(19) United States
(12) Patent Application Publication
(10) Pub. No.: US 2026/0042205 A1
(43) Pub. Date: Feb. 12, 2026

(54) OBJECT-CENTRIC DIFFUSION POLICY FOR EFFICIENT IMITATION LEARNING

(71) Applicant: NVIDIA Corp., Santa Clara, CA (US)

(72) Inventors: Bowen Wen, Issaquah, WA (US); Stanley Thomas Birchfield, Sammamish, WA (US); Joydeep Biswas, Austin, TX (US); Yuke Zhu, Austin, TX (US); Xiaolong Wang, San Diego, CA (US); Jie Xu, Bellevue, WA (US); Yashraj Shyam Narang, Mountain View, CA (US); Cheng-Chun Hsu, Austin, TX (US)

(73) Assignee: NVIDIA Corp., Santa Clara, CA (US)

(21) Appl. No.: 19/294,064

(22) Filed: Aug. 7, 2025

Related U.S. Application Data
(60) Provisional application No. 63/681,686, filed on Aug. 9, 2024.

(51) Int. Cl. B25J 9/16

(52) U.S. Cl. CPC B25J 9/1661; B25J 9/1664

(57) ABSTRACT

Robotic control systems that include a diffusion model configured by training on demonstration videos of tasks performed by humans, the diffusion model configured to transform a noise pattern and pose of an object manipulated in a task into a prediction of a next pose of the object in the task, and the system configured to generate an ending pose prediction for the task.

### CROSS-REFERENCE TO RELATED APPLICATIONS

This application claims priority and benefit under 35 U.S.C. 119(e) to U.S. application Ser. No. 63/681,686, “Object-Centric Diffusion Policy for Efficient Imitation Learning”, filed on Aug. 9, 2024, the contents of which are incorporated herein by reference in their entirety.

### BACKGROUND

Configuring robots to perform tasks efficiently and reliably is useful in a variety of contexts including manufacturing, service industries, and home use. Imitation learning is a mechanism by which a deep learning model utilized as a robotic controller learns to replicate a human expert's actions through exposure to human demonstrations of the tasks to learn (the policy).

The accuracy of task learning mechanisms tends to improve with increases in the number of demonstrations utilized in the training process. However, it may be costly to scale policy learning due to the human and computational resources involved. In some cases, useful demonstrations may be difficult to generate or obtain. Collecting robotic demonstrations may be likewise costly and slow.

In some cases, a deep learning model trained with specific demonstrations may not generalize well, meaning it may perform poorly on tasks not specifically provided in the training demonstrations. Even after training on many demonstrations, the generalizability of the robot to performing the policy in novel scene configurations, lighting environments, and other unrepresented contexts not represented in the training demonstrations may be insufficiently robust.

Previous efforts to address these limitations involve the application of additional mechanisms to the robotic training process to lessen the need for large quantities of costly demonstrations during training. These include visual pre-training, learning reward functions, extracting affordances, detecting hand poses, and translating domains. These mechanisms may still necessitate the collection of large numbers of training demonstrations to generalize adequately.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a system configured to transform a scene observation into a robotic action.

FIG. 2 depicts a process and system for generating demonstration trajectories from demonstration videos.

FIG. 3 depicts a process and system for generating pose predictions for use in a robotic task.

FIG. 4 depicts the trajectory diffusion model utilized for closed-loop control of a robotic manipulator.

FIG. 5 depicts a parallel processing unit in accordance with one embodiment.

FIG. 6 depicts a general processing cluster in accordance with one embodiment.

FIG. 7 depicts a memory partition unit in accordance with one embodiment.

FIG. 8 depicts a streaming multiprocessor in accordance with one embodiment.

FIG. 9 depicts a processing system in accordance with one embodiment.

FIG. 10 depicts an exemplary processing system in accordance with another embodiment.

FIG. 11 depicts a graphics processing pipeline in accordance with one embodiment.

### DETAILED DESCRIPTION

Conventional approaches have attempted to predict hand-object segmentation masks, point trajectories, and future video frames as context-agnostic action demonstrations for cross-context transfer of robotic task learning. However, these representations are limited to a two-dimensional (2D) configuration space and are unable to account for complex three-dimensional (3D) transformations, such as precision positioning and large rotation of objects.

The disclosed mechanisms utilize object-centric pose trajectories to accurately capture complex transformations. The disclosed mechanisms train an object-centric diffusion policy as a foundation model. The policy is represented by an object pose trajectory, which is a sequence of an object's 6D poses from start to completion of a task. Herein “6D” refers to three position coordinates, e.g., for a bounding cube centroid, and three orientation coordinates/values.

The object pose trajectory comprises a higher information content than 2D pixel-based representations, e.g., point trajectory, hand-object mask, or affordance, and may represent complex translation and/or rotation in 3D configuration space. Compared with conventional mechanisms, the use of 6D poses enables improved robotic performance and precision with higher computational efficiency. The disclosed mechanisms may facilitate imitation learning of complex robotic tasks solely or primarily from computer simulations, obviating the need for human demonstrations for training.

For robotic training/configuration, demonstrations may be collected from sequential inputs of object movement, including but not limited to simulated robot demonstrations and web-scale (meaning, efficiently available and sourced from global data networks) videos of human demonstrations.

The object-centric policy representation may serve as a universal task abstraction for different task scenarios. That is, the disclosed models may be deployed to new tasks that were not demonstrated during training.

The disclosed models learn an object-centric policy. A task or task policy to learn may be represented by a trajectory of object poses, i.e., a series of transformations describing the object's 6D poses during the task the learn.

An object-centric policy may function as a universal abstraction for various diverse tasks. This contrasts with conventional mechanisms that learn a robot's end-effector actions and thereby tightly couple the policy with a particular robotic agent. Consequently, the disclosed models may be more hardware platform-independent and adaptable to use with different robots than are conventional mechanisms.

The trajectory of object poses provide a more comprehensive action representation than existing 2D pixel-based approaches. They may efficiently capture complex translational and rotational movement within 3D space. The disclosed mechanisms may demonstrate improved performance and accuracy compared to existing techniques while utilizing less training data and may be implemented with higher computational efficiency (reduced computational resources such as memory, energy, and processor residency).

The disclosed mechanisms are versatile, enabling for demonstrations to be sourced from a variety of sources that feature object manipulations. This includes, but is not limited to, robotic demonstrations and web-scale human video data available online. The disclosed mechanisms may therefore significantly diminish the need for laborious data collection and may advance development and utilization of robots in manufacturing, medicine, and domestic applications, among others.

Given an observation (e.g., an image or video), the disclosed mechanisms estimate the pose of one or more objects in the observation and predict the object's future path. From the future path prediction, the disclosed mechanisms derive an action (e.g., one or more commands) to control a robotic manipulator. The disclosed mechanisms comprise a diffusion model configured (trained) using demonstration trajectories extracted from videos while remaining hardware platform-independent.

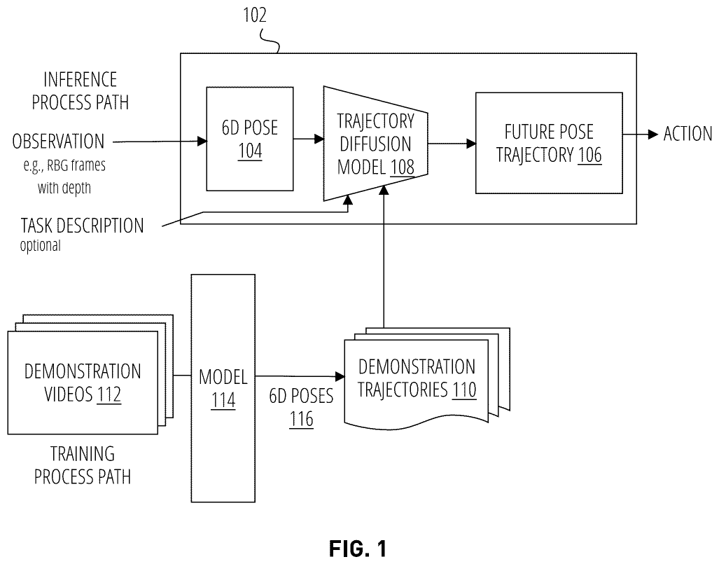

FIG. 1 depicts a system 102 configured (trained) to transform a scene observation (e.g., an image or video) into a robotic action (e.g., command). The system 102 generates a 6D pose 104 for an object in the scene observation and estimates a future pose trajectory 106 of the object by applying a trajectory diffusion model 108 to the 6D pose 104. The trajectory diffusion model 108 may be trained using demonstration trajectories 110 derived from demonstration videos 112.

Diffusion-based generative artificial intelligence comprises a class of generative models that utilize diffusion processes to generate outputs such as images or text sequences.

These models operate via the iterative transformation of noise patterns into meaningful content. In a forward diffusion process the model begins with an input distribution (e.g., a set of images) and incrementally corrupts the distribution by injecting Gaussian noise over several iterations until the inputs becomes indistinguishable from pure noise. This process defines a path from inputs to noise.

In a reverse diffusion process, the inputs are reconstructed from the noise. The model is configured (learns) to gradually denoise the corrupted data in steps that reverse the forward diffusion process, transforming noise into coherent meaningful outputs.

A model may be trained to learn the reverse diffusion process by minimizing a loss function, usually based on the difference between real inputs and reconstructed inputs at each step. This approach leverages the principles of stochastic processes and Markov chains to implement high-quality generative models. Diffusion-based models have proven to be effective in generating high-fidelity images, often outperforming other generative approaches in terms of diversity and quality.

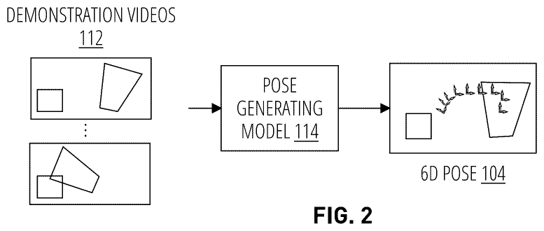

FIG. 2 depicts a process and system for generating demonstration trajectories 110 from demonstration videos 112 (e.g., videos formatted in RBG with a depth layer) by processing the demonstration videos 112 through 1 pose generating model 114.

Conventional mechanisms utilize diffusion to synthesize video demonstrations. However the disclosed mechanisms utilize diffusion to perform inference on video demonstrations provided from a camera, for example sourced from a mobile phone camera.

For training purposes, an object to track across frames of the demonstration videos 112 may be identified and posed in 6D using one of a number of available pose generating models 114. One such tool is YOLO-World, a zero-shot, real-time, open-vocabulary object detection model that applies vision-language modeling to identify a wide range of objects in videos or images. The YOLO-World model is pre-training on extensive datasets to enable flexible object detection in various scenarios.

Being a zero-shot inference tool, YOLO-World can identify objects without being explicitly trained on a specific set of classes. The model utilizes the computational speed of convolutional neural networks for efficient and swift object detection. The model can recognize a broad range of objects, not just those it was specifically trained to find. Users may provide text prompts to specify custom detection classes without retraining the model.

YOLO-World combines a vision model (YOLO) with a language model (CLIP). The YOLO model extracts features from the input, and the CLIP model encodes the text prompt into a text embedding. By comparing the visual features and text embeddings, YOLO-World may identify objects described in the prompt within the image.

Another tool that may be applied to generate object boundaries is the SAM-6D model. The SAM-6D model provides zero-shot 6D object pose estimation, detecting and determining the 3D position and orientation of objects it hasn't been specifically trained on. SAM-6D comprises a variation of the Segment Anything Model (SAM) for strong zero-shot transfer capabilities in instance segmentation. It extends SAM's basic capabilities to achieve 6D pose estimation, which involves determining both the position and orientation (rotation) of an object in 3D space.

The model may utilize two sub-networks: an instance segmentation model (ISM) and a pose estimation model (PEM). The ISM uses the SAM model (e.g., SAM-6D) to generate object proposals within an image, and calculates an “object matching score” for each proposal to determine if it corresponds to the target object, based on semantics, appearance, and geometry. The PEM predicts a 6D pose of the object based on the proposals identified by the ISM. The PEM comprises a two-stage process (coarse and fine matching), and utilizes “background tokens” to handle the challenge of point set matching, as objects may be occluded or have inaccurate segmentations.

The model does not transform actions depicted in the videos directly into motions and forces by robotic arms.

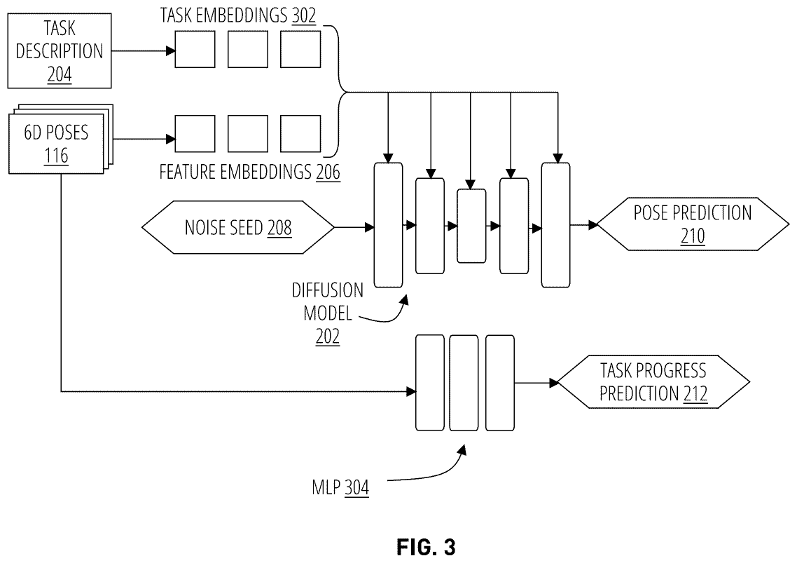

FIG. 3 depicts a process and system for generating pose predictions for use in a robotic task. A transformer model is configured to infer pose trajectories for objects manipulated by a robot using a diffusion model 202, such as a U-Net. A task description 204 and 6D poses 116 are converted into task embeddings 302 and feature embeddings 206, respectively, in the diffusion model 202. The diffusion model 202 thus configured may transform, via a sequence of denoising steps, noise seeds 208 for the specified task description 204 into pose predictions 210 estimating 6D poses for an object to take on at each time step of a robotic manipulation task.

There's less information in a sequence of pose predictions 210 than in a <state, action>representation utilized to control many robotic motions. For example, the pose prediction 210 does not instruct the robot on how to move between pose positions or how how much force or torque to apply to the object being manipulated. The pose prediction 210 may also lack information on the rigidity or slipperiness of the object being manipulated.

The pose predictions 210 provide a sequence of state representations of the objects at each time step of the task encoded in the task description 204. These pose prediction 210 are independent of any particular robotic platform. The motion and force control of specific effectors may be obtained by applying pose predictions 210 at timestep t and t+1 to action generators 402, e.g., inverse kinematics solver tools, for particular robotic manipulators.

The 6D poses 116 for a task may be sufficient input to the system for many applications, with the task description 204 providing optional language guidance for the task. The number of 6D poses 116 provided as input is implementation-specific. In one embodiment, only a single 6D pose is input. In another embodiment, multiple poses in the task sequence are provide to provide greater context for the pose predictions 210.

The task description 204 provides an additional condition to help the system distinguish trajectories from among the multiple tasks it has been trained on. The task description 204 may be encoded into the task embeddings 302 using known mechanisms, such as CLIP. CLIP (Contrastive Language-Image Pretraining) language embedding refers to a conventional process of encoding text in a way that aligns with image representations, enabling the model to understand and relate language and visual information. CLIP is enabled for this operation by training on a diverse dataset of text-image pairs. The model learns to predict which text corresponds to a given image, resulting in embeddings that capture the semantics of the language in relation to visual context.

The diffusion model 202 performs denoising of a noise seed 208 pattern over a series of denoising steps to generate the pose prediction 210. The noise seed 208 denoises over a series of internal iterations (e.g., through multiple encoding/decoding blocks) into a pose trajectory conditioned based on the task embeddings 302 of the input task description 204 and feature embeddings 206 of the one or more input 6D poses 116. The diffusion model 202 is configured via its training to generalize to different objects, object positions, and object orientations. The selected noise seed 208 may also be conditioned on the task embeddings 302 and feature embeddings 206.

A U-Net one choice for the diffusion model 202, but other diffusion network structures may also be utilized.

In a second path, one or more of the 6D poses 116 is processed through a network such as a multi-layer perceptron 304 to generate a task progress prediction 212. In one embodiment, the task progress prediction 212 is a fraction between 0 and 1, with larger values indicating closer proximity to an end state for the task. The pose or posed utilized in this path may be derived from a camera observation 404 of an actual state of the object being handled by the robotic manipulator 406 during deployment. The task progress prediction 212 is a progress prediction toward a stopping point of the object manipulation task and hence a prediction of progress toward an end state of the robotic task. When the camera observation 404 embodies an task progress prediction 212 pose to a sufficient degree (e.g., close to 1, configurable per task/robotic implementation), the task may be deemed completed and the robotic manipulator 406 instructed to release the object. During training with the demonstration videos 112, the system may learn which pose configurations corresponds to a completed task.

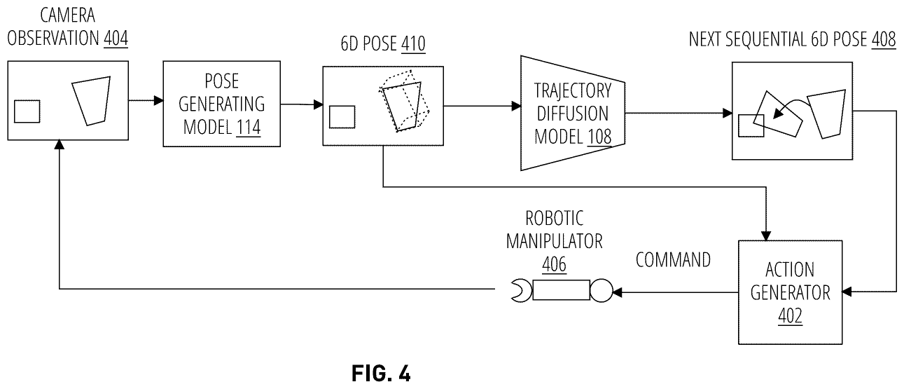

FIG. 4 depicts the trajectory diffusion model 108 utilized for closed-loop control of a robotic manipulator 406.

In deployment, the trajectory diffusion model 108 predicts a next sequential 6D pose 408 that the object should take on after the current one. A trajectory path for the object being manipulated is predicted from a provided starting point to the task progress prediction 212 pose, one iteration at a time.

To improve closed loop control of the robotic manipulator 406, a camera observation 404 of the object may be taken after each iteration, converted to a 6D pose 410, fed to the trajectory diffusion model 108 to improve the pose prediction in the next iteration.

The system predicts the next sequential 6D pose 408 of the object under manipulation, and not the motions or forces to transition from the current pose to the next pose. An action generator 402 (e.g., inverse kinematic tool) specific to the particular robotic manipulator 406 may be engaged to generate the motion and force commands to translate the object from its current 6D pose 410 to the next sequential 6D pose 408. When determining the robotic motion and force commands, the action generator 402 may into account object properties such as delicacy, slipperiness, and deformity.

The mechanisms disclosed herein may be implemented in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary computing systems will now be described that may be configured to implement the mechanisms disclosed herein, e.g., utilizing machine-readable instructions stored in a memory 520 and applied to one or more graphics processing unit and/or central processing unit 902, e.g., parallel processing unit 502 and/or central processing unit 902.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar”refers to a “crossbar”.

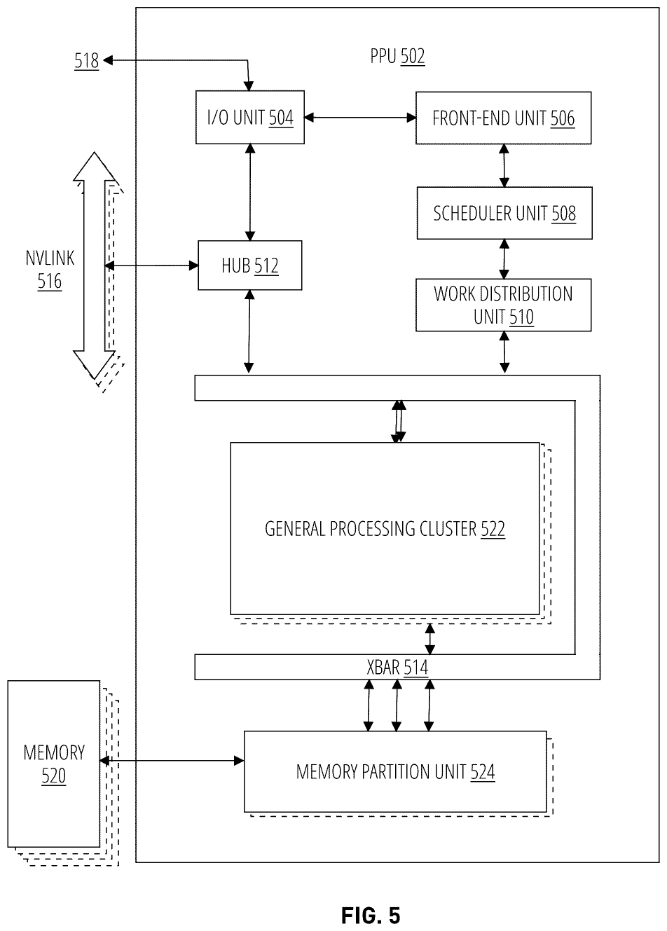

FIG. 5 depicts a parallel processing unit 502, in accordance with an embodiment. In an embodiment, the parallel processing unit 502 is a multi-threaded processor that is implemented on one or more integrated circuit devices. The parallel processing unit 502 is a latency hiding architecture designed to process many threads in parallel. A thread (e.g., a thread of execution) is an instantiation of a set of instructions configured to be executed by the parallel processing unit 502. In an embodiment, the parallel processing unit 502 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 502 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 502 modules may be configured to accelerate thousands of High Performance Computing (HPC), data center, and machine learning applications. The parallel processing unit 502 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 502 includes an I/O unit 504, a front-end unit 506, a scheduler unit 508, a work distribution unit 510, a hub 512, a crossbar 514, one or more general processing cluster 522 modules, and one or more memory partition unit 524 modules. The parallel processing unit 502 may be connected to a host processor or other parallel processing unit 502 modules via one or more high-speed NVLink 516 interconnects. The parallel processing unit 502 may be connected to a host processor or other peripheral devices via an interconnect 518. The parallel processing unit 502 may also be connected to a local memory comprising a number of memory 520 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 520 may comprise logic to configure the parallel processing unit 502 to carry out aspects of the techniques disclosed herein.

The NVLink 516 interconnect enables systems to scale and include one or more parallel processing unit 502 modules combined with one or more CPUs, supports cache coherence between the parallel processing unit 502 modules and CPUs, and CPU mastering.

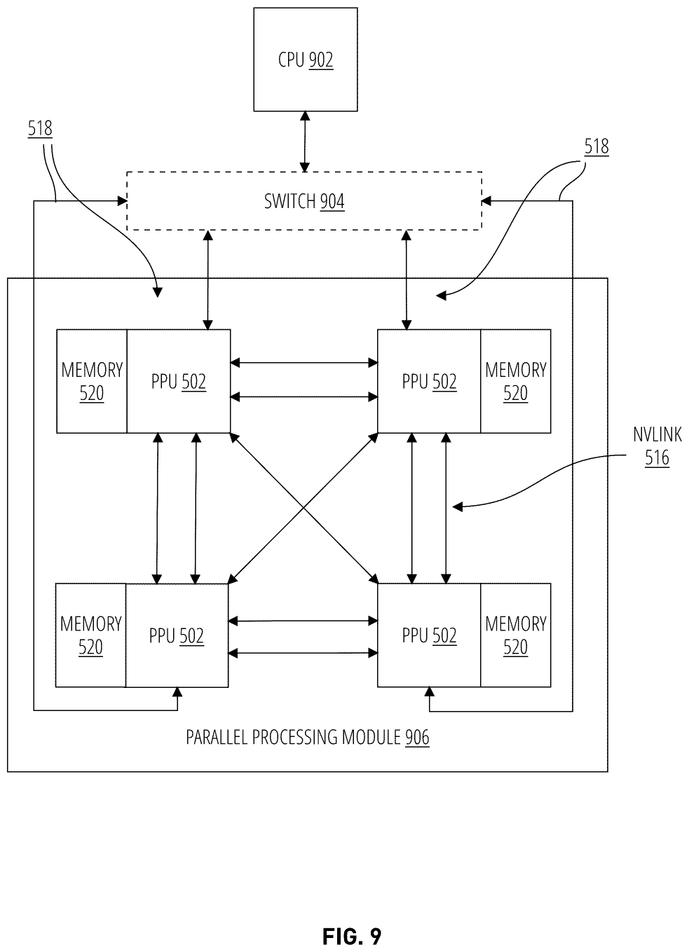

Data and/or commands may be transmitted by the NVLink 516 through the hub 512 to/from other units of the parallel processing unit 502 such as one or more copy engines, a video encoder, a video decoder, a power management unit, etc. (not explicitly shown). The NVLink 516 is described in more detail in conjunction with FIG. 9.

The I/O unit 504 is configured to transmit and receive communications (e.g., commands, data, etc.) from a host processor (not shown) over the interconnect 518. The I/O unit 504 may communicate with the host processor directly via the interconnect 518 or through one or more intermediate devices such as a memory bridge. In an embodiment, the I/O unit 504 may communicate with one or more other processors, such as one or more parallel processing unit 502 modules via the interconnect 518. In an embodiment, the I/O unit 504 implements a Peripheral Component Interconnect Express (PCIe) interface for communications over a PCIe bus and the interconnect 518 is a PCIe bus. In alternative embodiments, the I/O unit 504 may implement other types of well-known interfaces for communicating with external devices.

The I/O unit 504 decodes packets received via the interconnect 518. In an embodiment, the packets represent commands configured to cause the parallel processing unit 502 to perform various operations. The I/O unit 504 transmits the decoded commands to various other units of the parallel processing unit 502 as the commands may specify. For example, some commands may be transmitted to the front-end unit 506. Other commands may be transmitted to the hub 512 or other units of the parallel processing unit 502 such as one or more copy engines, a video encoder, a video decoder, a power management unit, etc. (not explicitly shown). In other words, the I/O unit 504 is configured to route communications between and among the various logical units of the parallel processing unit 502.

In an embodiment, a program executed by the host processor encodes a command stream in a buffer that provides workloads to the parallel processing unit 502 for processing. A workload may comprise several instructions and data to be processed by those instructions. The buffer is a region in a memory that is accessible (e.g., read/write) by both the host processor and the parallel processing unit 502. For example, the I/O unit 504 may be configured to access the buffer in a system memory connected to the interconnect 518 via memory requests transmitted over the interconnect 518. In an embodiment, the host processor writes the command stream to the buffer and then transmits a pointer to the start of the command stream to the parallel processing unit 502. The front-end unit 506 receives pointers to one or more command streams. The front-end unit 506 manages the one or more streams, reading commands from the streams and forwarding commands to the various units of the parallel processing unit 502.

The front-end unit 506 is coupled to a scheduler unit 508 that configures the various general processing cluster 522 modules to process tasks defined by the one or more streams. The scheduler unit 508 is configured to track state information related to the various tasks managed by the scheduler unit 508. The state may indicate which general processing cluster 522 a task is assigned to, whether the task is active or inactive, a priority level associated with the task, and so forth. The scheduler unit 508 manages the execution of a plurality of tasks on the one or more general processing cluster 522 modules.

The scheduler unit 508 is coupled to a work distribution unit 510 that is configured to dispatch tasks for execution on the general processing cluster 522 modules. The work distribution unit 510 may track a number of scheduled tasks received from the scheduler unit 508. In an embodiment, the work distribution unit 510 manages a pending task pool and an active task pool for each of the general processing cluster 522 modules. The pending task pool may comprise a number of slots (e.g., 32 slots) that contain tasks assigned to be processed by a particular general processing cluster 522. The active task pool may comprise a number of slots (e.g., 4 slots) for tasks that are actively being processed by the general processing cluster 522 modules. As a general processing cluster 522 finishes the execution of a task, that task is evicted from the active task pool for the general processing cluster 522 and one of the other tasks from the pending task pool is selected and scheduled for execution on the general processing cluster 522. If an active task has been idle on the general processing cluster 522, such as while waiting for a data dependency to be resolved, then the active task may be evicted from the general processing cluster 522 and returned to the pending task pool while another task in the pending task pool is selected and scheduled for execution on the general processing cluster 522.

The work distribution unit 510 communicates with the one or more general processing cluster 522 modules via crossbar 514. The crossbar 514 is an interconnect network that couples many of the units of the parallel processing unit 502 to other units of the parallel processing unit 502. For example, the crossbar 514 may be configured to couple the work distribution unit 510 to a particular general processing cluster 522. Although not shown explicitly, one or more other units of the parallel processing unit 502 may also be connected to the crossbar 514 via the hub 512.

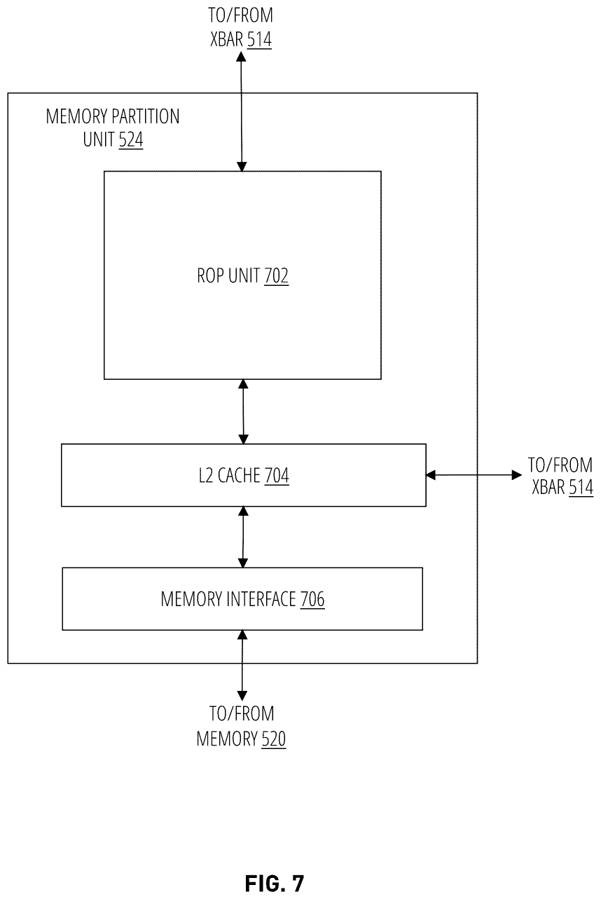

The tasks are managed by the scheduler unit 508 and dispatched to a general processing cluster 522 by the work distribution unit 510. The general processing cluster 522 is configured to process the task and generate results. The results may be consumed by other tasks within the general processing cluster 522, routed to a different general processing cluster 522 via the crossbar 514, or stored in the memory 520. The results can be written to the memory 520 via the memory partition unit 524 modules, which implement a memory interface for reading and writing data to/from the memory 520. The results can be transmitted to another parallel processing unit 502 or CPU via the NVLink 516. In an embodiment, the parallel processing unit 502 includes a number U of memory partition unit 524 modules that is equal to the number of separate and distinct memory 520 devices coupled to the parallel processing unit 502. A memory partition unit 524 will be described in more detail below in conjunction with FIG. 7.

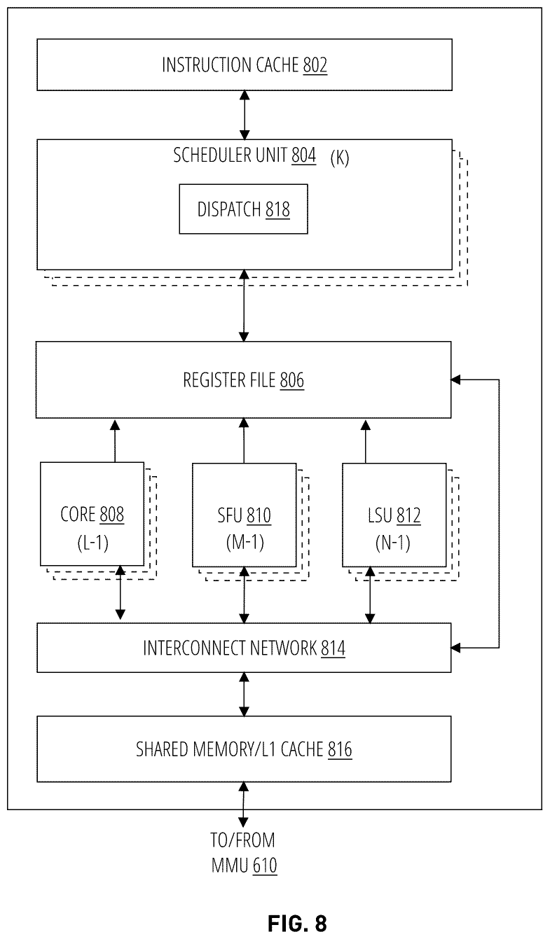

In an embodiment, a host processor executes a driver kernel that implements an application programming interface (API) that enables one or more applications executing on the host processor to schedule operations for execution on the parallel processing unit 502. In an embodiment, multiple compute applications are simultaneously executed by the parallel processing unit 502 and the parallel processing unit 502 provides isolation, quality of service (QoS), and independent address spaces for the multiple compute applications. An application may generate instructions (e.g., API calls) that cause the driver kernel to generate one or more tasks for execution by the parallel processing unit 502. The driver kernel outputs tasks to one or more streams being processed by the parallel processing unit 502. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

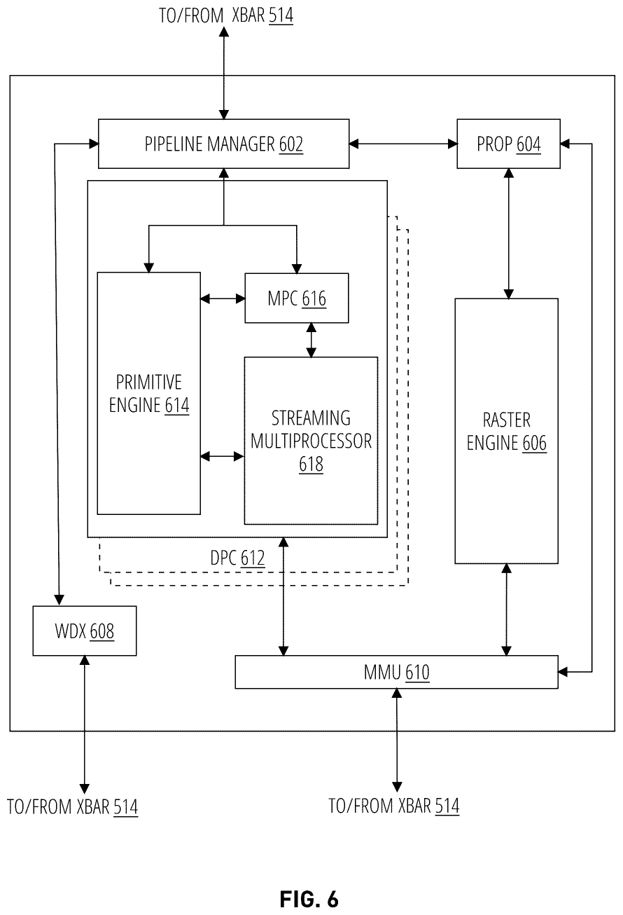

FIG. 6 depicts a general processing cluster 522 of the parallel processing unit 502 of FIG. 5, in accordance with an embodiment. As shown in FIG. 6, each general processing cluster 522 includes a number of hardware units for processing tasks. In an embodiment, each general processing cluster 522 includes a pipeline manager 602, a pre-raster operations unit 604, a raster engine 606, a work distribution crossbar 608, a memory management unit 610, and one or more data processing cluster 612. It will be appreciated that the general processing cluster 522 of FIG. 6 may include other hardware units in lieu of or in addition to the units shown in FIG. 6.

In an embodiment, the operation of the general processing cluster 522 is controlled by the pipeline manager 602. The pipeline manager 602 manages the configuration of the one or more data processing cluster 612 modules for processing tasks allocated to the general processing cluster 522. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 618. The pipeline manager 602 may also be configured to route packets received from the work distribution unit 510 to the appropriate logical units within the general processing cluster 522. For example, some packets may be routed to fixed function hardware units in the pre-raster operations unit 604 and/or raster engine 606 while other packets may be routed to the data processing cluster 612 modules for processing by the primitive engine 614 or the streaming multiprocessor 618. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 522 includes an M-pipe controller 616, a primitive engine 614, and one or more streaming multiprocessor 618 modules. The M-pipe controller 616 controls the operation of the data processing cluster 612, routing packets received from the pipeline manager 602 to the appropriate units in the data processing cluster 612. For example, packets associated with a vertex may be routed to the primitive engine 614, which is configured to fetch vertex attributes associated with the vertex from the memory 520. In contrast, packets associated with a shader program may be transmitted to the streaming multiprocessor 618.

The streaming multiprocessor 618 comprises a programmable streaming processor that is configured to process tasks represented by a number of threads. Each streaming multiprocessor 618 is multi-threaded and configured to execute a plurality of threads (e.g., 32 threads) from a particular group of threads concurrently. In an embodiment, the streaming multiprocessor 618 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 618 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 618 will be described in more detail below in conjunction with FIG. 8.

The memory management unit 610 provides an interface between the general processing cluster 522 and the memory partition unit 524. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 520.

FIG. 7 depicts a memory partition unit 524 of the parallel processing unit 502 of FIG. 5, in accordance with an embodiment. As shown in FIG. 7, the memory partition unit 524 includes a raster operations unit 702, a level two cache 704, and a memory interface 706. The memory interface 706 is coupled to the memory 520. Memory interface 706 may implement 32, 64, 128, 1024-bit data buses, or the like, for high-speed data transfer. In an embodiment, the parallel processing unit 502 incorporates U memory interface 706 modules, one memory interface 706 per pair of memory partition unit 524 modules, where each pair of memory partition unit 524 modules is connected to a corresponding memory 520 device. For example, parallel processing unit 502 may be connected to up to Y memory 520 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 502, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 520 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 502 modules process very large datasets and/or run applications for extended periods.

In an embodiment, the parallel processing unit 502 implements a multi-level memory hierarchy. In an embodiment, the memory partition unit 524 supports a unified memory to provide a single unified virtual address space for CPU and parallel processing unit 502 memory, enabling data sharing between virtual memory systems. In an embodiment the frequency of accesses by a parallel processing unit 502 to memory located on other processors is traced to ensure that memory pages are moved to the physical memory of the parallel processing unit 502 that is accessing the pages more frequently. In an embodiment, the NVLink 516 supports address translation services allowing the parallel processing unit 502 to directly access a CPU's page tables and providing full access to CPU memory by the parallel processing unit 502.

In an embodiment, copy engines transfer data between multiple parallel processing unit 502 modules or between parallel processing unit 502 modules and CPUs. The copy engines can generate page faults for addresses that are not mapped into the page tables. The memory partition unit 524 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 520 or other system memory may be fetched by the memory partition unit 524 and stored in the level two cache 704, which is located on-chip and is shared between the various general processing cluster 522 modules. As shown, each memory partition unit 524 includes a portion of the level two cache 704 associated with a corresponding memory 520 device. Lower level caches may then be implemented in various units within the general processing cluster 522 modules. For example, each of the streaming multiprocessor 618 modules may implement an L1 cache. The L1 cache is private memory that is dedicated to a particular streaming multiprocessor 618. Data from the level two cache 704 may be fetched and stored in each of the L1 caches for processing in the functional units of the streaming multiprocessor 618 modules. The level two cache 704 is coupled to the memory interface 706 and the crossbar 514.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 524 modules may be different than the number of general processing cluster 522 modules and, therefore, each raster operations unit 702 may be coupled to each of the general processing cluster 522 modules. The raster operations unit 702 tracks packets received from the different general processing cluster 522 modules and determines which general processing cluster 1 that a result generated by the raster operations unit 702 is routed to through the crossbar 514. Although the raster operations unit 702 is included within the memory partition unit 524 in FIG. 7, in other embodiment, the raster operations unit 702 may be outside of the memory partition unit 524. For example, the raster operations unit 702 may reside in the general processing cluster 522 or another unit.

FIG. 8 illustrates the streaming multiprocessor 618 of FIG. 6, in accordance with an embodiment. As shown in FIG. 8, the streaming multiprocessor 618 includes an instruction cache 802, one or more scheduler unit 804 modules (e.g., such as scheduler unit 508), a register file 806, one or more processing core 808 modules, one or more special function unit 810 modules, one or more load/store unit 812 modules, an interconnect network 814, and a shared memory/L1 cache 816.

As described above, the work distribution unit 510 dispatches tasks for execution on the general processing cluster 522 modules of the parallel processing unit 502. The tasks are allocated to a particular data processing cluster 612 within a general processing cluster 522 and, if the task is associated with a shader program, the task may be allocated to a streaming multiprocessor 618. The scheduler unit 508 receives the tasks from the work distribution unit 510 and manages instruction scheduling for one or more thread blocks assigned to the streaming multiprocessor 618. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms.

Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 618 includes a register file 806 that provides a set of registers for the functional units of the streaming multiprocessor 618. In an embodiment, the register file 806 is divided between each of the functional units such that each functional unit is allocated a dedicated portion of the register file 806. In another embodiment, the register file 806 is divided between the different warps being executed by the streaming multiprocessor 618. The register file 806 provides temporary storage for operands connected to the data paths of the functional units.

Each streaming multiprocessor 618 comprises L processing core 808 modules. In an embodiment, the streaming multiprocessor 618 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 618 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 520 and sample the texture maps to produce sampled texture values for use in shader programs executed by the streaming multiprocessor 618. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 618 includes two texture units.

Each streaming multiprocessor 618 also comprises N load/store unit 812 modules that implement load and store operations between the shared memory/L1 cache 816 and the register file 806. Each streaming multiprocessor 618 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816.

The shared memory/L1 cache 816 is an array of on-chip memory that allows for data storage and communication between the streaming multiprocessor 618 and the primitive engine 614 and between threads in the streaming multiprocessor 618. In an embodiment, the shared memory/L1 cache 816 comprises 128KB of storage capacity and is in the path from the streaming multiprocessor 618 to the memory partition unit 524. The shared memory/L1 cache 816 can be used to cache reads and writes. One or more of the shared memory/L1 cache 816, level two cache 704, and memory 520are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 510 assigns and distributes blocks of threads directly to the data processing cluster 612 modules. The threads in a block execute the same program, using a unique thread ID in the calculation to ensure each thread generates unique results, using the streaming multiprocessor 618 to execute the program and perform calculations, shared memory/L1 cache 816 to communicate between threads, and the load/store unit 812 to read and write global memory through the shared memory/L1 cache 816 and the memory partition unit 524. When configured for general purpose parallel computation, the streaming multiprocessor 618 can also write commands that the scheduler unit 508 can use to launch new work on the data processing cluster 612 modules.

The parallel processing unit 502 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 502 is embodied on a single semiconductor substrate. In another embodiment, the parallel processing unit 502 is included in a system-on-a-chip (SoC) along with one or more other devices such as additional parallel processing unit 502 modules, the memory 520, a reduced instruction set computer (RISC) CPU, a memory management unit (MMU), a digital-to-analog converter (DAC), and the like.

In an embodiment, the parallel processing unit 502 may be included on a graphics card that includes one or more memory devices. The graphics card may be configured to interface with a PCIe slot on a motherboard of a desktop computer. In yet another embodiment, the parallel processing unit 502 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system implemented using the parallel processing unit 502 of FIG. 5, in accordance with an embodiment. The processing system includes a central processing unit 902, an switch 904, and multiple parallel processing unit 502 modules each and respective memory 520 modules. The switch 904 is depicted with dashed lines, indicating that it is optional in some embodiments.

The NVLink 516 provides high-speed communication links between each of the parallel processing unit 502 modules. Although a particular number of NVLink 516 and interconnect 518 connections are illustrated in FIG. 9, the number of connections to each parallel processing unit 502 and the central processing unit 902 may vary. The switch 904 interfaces between the interconnect 518 and the central processing unit 902. The parallel processing unit 502 modules, memory 520 modules, and NVLink 516 connections may be situated on a single semiconductor platform to form a parallel processing module 906. In an embodiment, the switch 904 supports two or more protocols to interface between various different connections and/or links.

In another embodiment (not shown), the NVLink 516 provides one or more high-speed communication links between each of the parallel processing unit modules (parallel processing unit 502, parallel processing unit 502, parallel processing unit 502, and parallel processing unit 502) and the central processing unit 902 and the switch 904 (when present) interfaces between the interconnect 518 and each of the parallel processing unit modules. The parallel processing unit modules, memory 520 modules, and interconnect 518 may be situated on a single semiconductor platform to form a parallel processing module 906. In yet another embodiment (not shown), the interconnect 518 provides one or more communication links between each of the parallel processing unit modules and the central processing unit 902 and the switch 904 interfaces between each of the parallel processing unit modules using the NVLink 516 to provide one or more high-speed communication links between the parallel processing unit modules. In another embodiment (not shown), the NVLink 516 provides one or more high-speed communication links between the parallel processing unit modules and the central processing unit 902 through the switch 904. In yet another embodiment (not shown), the interconnect 518 provides one or more communication links between each of the parallel processing unit modules directly. One or more of the NVLink 516 high-speed communication links may be implemented as a physical NVLink interconnect or either an on-chip or on-die interconnect using the same protocol as the NVLink 516.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 906 may be implemented as a circuit board substrate and each of the parallel processing unit modules and/or memory 520 modules may be packaged devices. In an embodiment, the central processing unit 902, switch 904, and the parallel processing module 906 are situated on a single semiconductor platform.

In an embodiment, each parallel processing unit module includes six NVLink 516 interfaces (as shown in FIG. 9, five NVLink 516 interfaces are included for each parallel processing unit module). The NVLink 516 may be operated exclusively for PPU-to-PPU communication as shown in FIG. 9, or some combination of PPU-to-PPU and PPU-to-CPU, when the central processing unit 902 also includes one or more NVLink 516 interfaces.

In an embodiment, the NVLink 516 allows direct load/store/atomic access from the central processing unit 902 to each parallel processing unit module's memory 520. In an embodiment, the NVLink 516 supports coherency operations, allowing data read from the memory 520 modules to be stored in the cache hierarchy of the central processing unit 902, reducing cache access latency for the central processing unit 902. In an embodiment, the NVLink 516 includes support for Address Translation Services (ATS), enabling the parallel processing unit module to directly access page tables within the central processing unit 902. One or more of the NVLink 516 may also be configured to operate in a low-power mode.

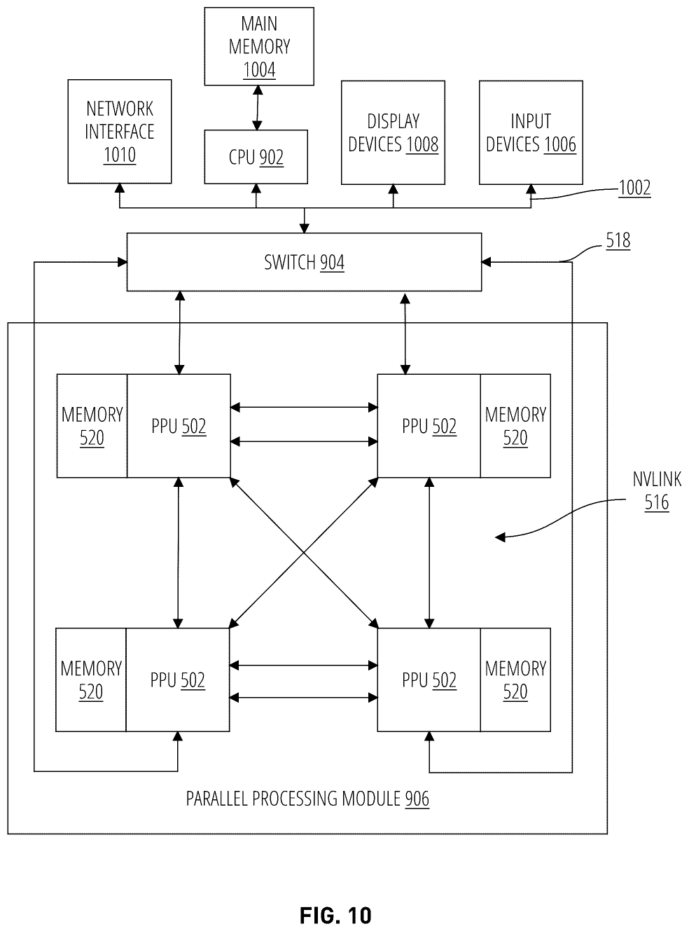

FIG. 10 depicts an exemplary processing system in which the various architecture and/or functionality of the various previous embodiments may be implemented. As shown, an exemplary processing system is provided including at least one central processing unit 902 that is connected to a communications bus 1002. The communication communications bus 1002 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1004. Control logic (software) and data are stored in the main memory 1004 which may take the form of random access memory (RAM). For simplicity of illustration, the main memory 1004 may be understood to comprise other forms of bulk memory, including non-volatile memory technologies.

The exemplary processing system also includes input devices 1006, the parallel processing module 906, and display devices 1008, e.g. a conventional CRT (cathode ray tube), LCD (liquid crystal display), LED (light emitting diode), plasma display or the like. User input may be received from the input devices 1006, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1010 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1004 and/or the secondary storage. Such computer programs, when executed, enable the exemplary processing system to perform various functions. The main memory 1004, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

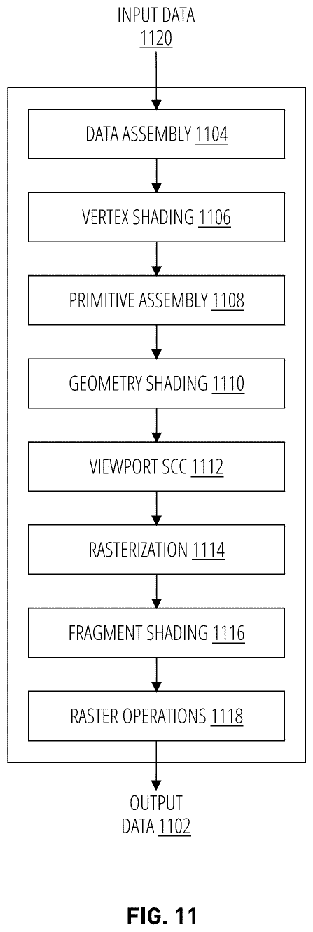

FIG. 11 is a conceptual diagram of a graphics processing pipeline implemented by the parallel processing unit 502 of FIG. 5, in accordance with an embodiment. In an embodiment, the parallel processing unit 502 comprises a graphics processing unit (GPU). The parallel processing unit 502 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 502 can be configured to process the graphics primitives to generate a frame buffer (e.g., pixel data for each of the pixels of the display).

An application writes model data for a scene (e.g., a collection of vertices and attributes) to a memory such as a system memory or memory 520. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 618 modules of the parallel processing unit 502 including one or more of a vertex shader, hull shader, domain shader, geometry shader, and a pixel shader. For example, one or more of the streaming multiprocessor 618 modules may be configured to execute a vertex shader program that processes a number of vertices defined by the model data. In an embodiment, the different streaming multiprocessor 618 modules may be configured to execute different shader programs concurrently. For example, a first subset of streaming multiprocessor 618 modules may be configured to execute a vertex shader program while a second subset of streaming multiprocessor 618 modules may be configured to execute a pixel shader program. The first subset of streaming multiprocessor 618 modules processes vertex data to produce processed vertex data and writes the processed vertex data to the level two cache 704 and/or the memory 520. After the processed vertex data is rasterized (e.g., transformed from three-dimensional data into two-dimensional data in screen space) to produce fragment data, the second subset of streaming multiprocessor 618 modules executes a pixel shader to produce processed fragment data, which is then blended with other processed fragment data and written to the frame buffer in memory 520. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline receives input data 601 that is transmitted from one stage to the next stage of the graphics processing pipeline to generate output data 1102. In an embodiment, the graphics processing pipeline may represent a graphics processing pipeline defined by the OpenGL® API. As an option, the graphics processing pipeline may be implemented in the context of the functionality and architecture of the previous Figures and/or any subsequent Figure(s).

As shown in FIG. 11, the graphics processing pipeline comprises a pipeline architecture that includes a number of stages. The stages include, but are not limited to, a data assembly 1104 stage, a vertex shading 1106 stage, a primitive assembly 1108 stage, a geometry shading 1110 stage, a viewport SCC 1112 stage, a rasterization 1114 stage, a fragment shading 1116 stage, and a raster operations 1118 stage. In an embodiment, the input data 1120 comprises commands that configure the processing units to implement the stages of the graphics processing pipeline and geometric primitives (e.g., points, lines, triangles, quads, triangle strips or fans, etc.) to be processed by the stages. The output data 1102 may comprise pixel data (e.g., color data) that is copied into a frame buffer or other type of surface data structure in a memory.

The data assembly 1104 stage receives the input data 1120 that specifies vertex data for high-order surfaces, primitives, or the like. The data assembly 1104 stage collects the vertex data in a temporary storage or queue, such as by receiving a command from the host processor that includes a pointer to a buffer in memory and reading the vertex data from the buffer. The vertex data is then transmitted to the vertex shading 1106 stage for processing.

The vertex shading 1106 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1106 stage may manipulate individual vertex attributes such as position, color, texture coordinates, and the like. In other words, the vertex shading 1106 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1106 stage generates transformed vertex data that is transmitted to the primitive assembly 1108 stage.

The primitive assembly 1108 stage collects vertices output by the vertex shading 1106 stage and groups the vertices into geometric primitives for processing by the geometry shading 1110 stage. For example, the primitive assembly 1108 stage may be configured to group every three consecutive vertices as a geometric primitive (e.g., a triangle) for transmission to the geometry shading 1110 stage. In some embodiments, specific vertices may be reused for consecutive geometric primitives (e.g., two consecutive triangles in a triangle strip may share two vertices). The primitive assembly 1108 stage transmits geometric primitives (e.g., a collection of associated vertices) to the geometry shading 1110 stage.

The geometry shading 1110 stage processes geometric primitives by performing a set of operations (e.g., a geometry shader or program) on the geometric primitives. Tessellation operations may generate one or more geometric primitives from each geometric primitive. In other words, the geometry shading 1110 stage may subdivide each geometric primitive into a finer mesh of two or more geometric primitives for processing by the rest of the graphics processing pipeline. The geometry shading 1110 stage transmits geometric primitives to the viewport SCC 1112 stage.

In an embodiment, the graphics processing pipeline may operate within a streaming multiprocessor and the vertex shading 1106 stage, the primitive assembly 1108 stage, the geometry shading 1110 stage, the fragment shading 1116 stage, and/or hardware/software associated therewith, may sequentially perform processing operations. Once the sequential processing operations are complete, in an embodiment, the viewport SCC 1112 stage may utilize the data. In an embodiment, primitive data processed by one or more of the stages in the graphics processing pipeline may be written to a cache (e.g. L1 cache, a vertex cache, etc.). In this case, in an embodiment, the viewport SCC 1112 stage may access the data in the cache. In an embodiment, the viewport SCC 1112 stage and the rasterization 1114 stage are implemented as fixed function circuitry.

The viewport SCC 1112 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1114 stage.

The rasterization 1114 stage converts the 3D geometric primitives into 2D fragments (e.g. capable of being utilized for display, etc.). The rasterization 1114 stage may be configured to utilize the vertices of the geometric primitives to setup a set of plane equations from which various attributes can be interpolated. The rasterization 1114 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1114 stage generates fragment data (e.g., interpolated vertex attributes associated with a particular sample location for each covered pixel) that are transmitted to the fragment shading 1116 stage.

The fragment shading 1116 stage processes fragment data by performing a set of operations (e.g., a fragment shader or a program) on each of the fragments. The fragment shading 1116 stage may generate pixel data (e.g., color values) for the fragment such as by performing lighting operations or sampling texture maps using interpolated texture coordinates for the fragment. The fragment shading 1116 stage generates pixel data that is transmitted to the raster operations 1118 stage.

The raster operations 1118 stage may perform various operations on the pixel data such as performing alpha tests, stencil tests, and blending the pixel data with other pixel data corresponding to other fragments associated with the pixel. When the raster operations 1118 stage has finished processing the pixel data (e.g., the output data 1102), the pixel data may be written to a render target such as a frame buffer, a color buffer, or the like.

It will be appreciated that one or more additional stages may be included in the graphics processing pipeline in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1110 stage). Other types of graphics processing pipelines are contemplated as being within the scope of the present disclosure. Furthermore, any of the stages of the graphics processing pipeline may be implemented by one or more dedicated hardware units within a graphics processor such as parallel processing unit 502. Other stages of the graphics processing pipeline may be implemented by programmable hardware units such as the streaming multiprocessor 618 of the parallel processing unit 502.

The graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 502. The API provides an abstraction for a programmer that lets a programmer utilize specialized graphics hardware, such as the parallel processing unit 502, to generate the graphical data without requiring the programmer to utilize the specific instruction set for the parallel processing unit 502. The application may include an API call that is routed to the device driver for the parallel processing unit 502. The device driver interprets the API call and performs various operations to respond to the API call. In some instances, the device driver may perform operations by executing instructions on the CPU. In other instances, the device driver may perform operations, at least in part, by launching operations on the parallel processing unit 502 utilizing an input/output interface between the CPU and the parallel processing unit 502. In an embodiment, the device driver is configured to implement the graphics processing pipeline utilizing the hardware of the parallel processing unit 502.

Various programs may be executed within the parallel processing unit 502 in order to implement the various stages of the graphics processing pipeline. For example, the device driver may launch a kernel on the parallel processing unit 502 to perform the vertex shading 1106 stage on one streaming multiprocessor 618 (or multiple streaming multiprocessor 618 modules). The device driver (or the initial kernel executed by the parallel processing unit 502) may also launch other kernels on the parallel processing unit 502 to perform other stages of the graphics processing pipeline, such as the geometry shading 1110 stage and the fragment shading 1116 stage. In addition, some of the stages of the graphics processing pipeline may be implemented on fixed unit hardware such as a rasterizer or a data assembler implemented within the parallel processing unit 502. It will be appreciated that results from one kernel may be processed by one or more intervening fixed function hardware units before being processed by a subsequent kernel on a streaming multiprocessor 618.

### LISTING OF DRAWING ELEMENTS

102 system
104 6D pose
106 future pose trajectory
108 trajectory diffusion model
110 demonstration trajectory
112 demonstration video
114 pose generating model
116 6D poses
202 diffusion model
204 task description
206 feature embeddings
208 noise seed
210 pose prediction
212 task progress prediction
302 task embeddings
304 multi-layer perceptron
402 action generator
404 camera observation
406 robotic manipulator
408 next sequential 6D pose
410 6D pose
502 parallel processing unit
504 I/O unit
506 front-end unit
508 scheduler unit
510 work distribution unit
512 hub
514 crossbar
516 NVLink
518 interconnect
520 memory
522 general processing cluster
524 memory partition unit
602 pipeline manager
604 pre-raster operations unit
606 raster engine
608 work distribution crossbar
610 memory management unit
612 data processing cluster
614 primitive engine
616 M-pipe controller
618 streaming multiprocessor
702 raster operations unit
704 level two cache
706 memory interface
802 instruction cache
804 scheduler unit
806 register file
808 core
810 special function unit
812 load/store unit
814 interconnect network
816 shared memory/L1 cache
818 dispatch
902 central processing unit
904 switch
906 parallel processing module
1002 communications bus
1004 main memory
1006 input devices
1008 display devices
1010 network interface
1102 output data
1104 data assembly
1106 vertex shading
1108 primitive assembly
1110 geometry shading
1112 viewport SCC
1114 rasterization
1116 fragment shading
1118 raster operations
1120 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device.

Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to”perform that function after programming.

Reciting in the appended claims that a structure is “configured to” perform one or more tasks is expressly intended not to invoke 35 U.S. C. § 112(f) for that claim element.

Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A robotic control system comprising:
a diffusion model configured by training on demonstration videos of tasks;
the diffusion model configured to transform a noise pattern and pose of an object manipulated in a task into a prediction of at least one next pose of the object in the task; and
the system configured to generate a task progress prediction for the task.

2. The robotic control system of claim 1, wherein the diffusion model comprises a U-Net structure.

3. The robotic control system of claim 1, wherein the pose and next pose are six dimensional.

4. The robotic control system of claim 1, the diffusion model further configured to transform the noise pattern and the pose of the object manipulated in the task based on a task description.

5. The robotic control system of claim 4, wherein the task description comprises text.

6. The robotic control system of claim 1, further comprising a multi-layer perceptron configured to generate the task progress prediction for the task.

7. The robotic control system of claim 6, wherein the task progress prediction is a fraction between 0 and 1, with larger values indicating closer proximity to an end state for the task.

8. The robotic control system of claim 1, further comprising an action generator configured to transform the pose and the at least one next pose of the object into robotic control commands.

9. The robotic control system of claim 1, further comprising a camera configured to generate an image of an outcome of a robotic manipulation of the object into the at least one next pose.

10. The robotic control system of claim 9, further configured to convert the image to a pose applied to the diffusion model.

11. A robotic control process comprising:
operating a diffusion model to transform (a) a noise pattern, (b) a task description, and (c) a pose of an object manipulated in a robotic task, into a prediction of at least one next pose of the object in the robotic task;
generating a task progress prediction for the robotic task based on the pose; and
ending the robotic task on condition that the task progress prediction satisfies a stopping condition for the robotic task.

12. The robotic control process of claim 11, wherein the diffusion model comprises a U-Net structure.

13. The robotic control process of claim 11, wherein the pose and next pose are six dimensional.

14. The robotic control process of claim 11, wherein the task description is encoded as text.

15. The robotic control process of claim 11, further comprising:
operating a multi-layer perceptron to generate the task progress prediction for the robotic task.

16. The robotic control process of claim 15, wherein the task progress prediction is a fraction between 0 and 1, with larger values indicating closer proximity to the stopping condition.

17. The robotic control process of claim 11, further comprising:
generating a robotic action to transform the pose and the at least one next pose of the object into robotic control commands.

18. The robotic control process of claim 17, further comprising:
generating the robotic action with an inverse kinematics system.

19. The robotic control process of claim 11, further comprising:
capturing an image of an outcome of a robotic manipulation of the object into the at least one next pose.

20. The robotic control process of claim 19, further comprising:
converting the image to the pose of the object operated on by the diffusion model.

21. A robotic control system comprising:
at least one graphics processing unit;
a machine memory comprising machine-readable instructions that, when applied to the at least one graphics processing unit, configure the control system to:
operate a diffusion model to transform a noise pattern and at least one pose of an object manipulated in a robotic task, into a prediction of at least one next pose of the object in the robotic task;
generate a task progress prediction for the robotic task; and
end the robotic task on condition that the task progress prediction satisfies a stopping condition for the robotic task.
